(19) United States
(12) Patent Application Publication
(10) Pub. No.: US 2015/0027321 A1
(43) Pub. Date: Jan. 29, 2015

(54) BARBECUE SPIT WITH TEMPERATURE PROBE

(71) Applicant: Wei-Che YU, New Taipei City, (TW)

(72) Inventor: Wei-Che YU, New Taipei City, (TW)

(21) Appl. No.: 13/950,521

(22) Filed: Jul. 25, 2013

(51) Int. Cl. A47J 36/32; A47J 37/04

(52) U.S. Cl. CPC A47J 36/32; A47J 37/041
USPC 99/344

(57) ABSTRACT

The present invention is to provide a barbecue spit equipped with a probe, which includes a rod configured to pierce a food and connected to a power device of an electric barbecue apparatus so that the rod can be driven to rotate by the power device, a temperature setting device provided adjacent to one end of the rod and including a control module and an alert module, a conductive wire provided in the rod and having one end electrically connected to the setting device, and a probe having one end to be inserted into the food and an opposite end electrically connected to the other end of the conductive wire. Thus, when the food temperature measured by the probe reaches a predetermined temperature, the control module drives the alert module to generate an alert signal (e.g., a continuous sound), thereby informing the user of the roasted state of the food.

### FIELD OF THE INVENTION

The present invention relate to a barbecue spit, more particularly to a barbecue spit equipped with a temperature probe and a temperature setting device, such that when the device receives a food temperature measured by the probe and determines that the food temperature reaches a predetermined temperature, a control module in the device will drive an alert module to generate an alert signal (e.g., a continuous sound), thereby informing the user of the roasted state of the food, with a view to preventing the food from being burned.

### BACKGROUND OF THE INVENTION

Recently, people's way of life has gradually changed with the development of economic and trade activities. In addition to pursuing material enjoyment, more and more attention is paid to enhancement of the spiritual life. Consequently, people place increasing importance on recreation, and the various recreational activities provide tremendous business opportunities for the recreation industry. Barbecues, for example, are a very popular activity to be held outdoors. Generally speaking, if one side of the food being barbecued is left facing the heat source for a long time, this side of the food is very likely to be overheated or even charred, whereas the side facing away from the heat source is undercooked due to insufficient heating. It is therefore necessary to turn the food on a regular basis so that each part of the food is heated evenly. However, if it is required to turn the food manually and repeatedly, the one in charge of barbecuing (hereinafter referred to as the user) will have to keep a close eye on the heated state of the food, usually so close that the user is unable to take part in other activities (e.g., chatting, singing, or playing games) at the same time. The user must also watch the high temperature of the heat source so as not to be burned when turning the food. Obviously enough, turning the food manually compromises the relaxing and recreational effects expected of a barbecue.

As a solution to the aforesaid problems, and in order to enable high-quality barbecues, electric barbecue apparatuses were developed and are now commercially available. Basically, an electric barbecue apparatus includes a barbecue stove and a power device. The barbecue stove provides a heat source (e.g., by burning charcoal placed in the barbecue stove, by burning gas from a gas stove, or by turning on a halogen lamp in the barbecue stove). The power device, to which a grill rack or barbecue spit is connected, is mounted on the barbecue stove and configured for driving the grill rack or barbecue spit to rotate above the barbecue stove, thereby allowing the food supported on the grill rack or barbecue spit to be heated evenly by the heat source of the barbecue stove. As a user who cooks with such an electric barbecue apparatus can engage in other activities at the same time, the advent of such electric barbecue apparatuses has greatly enhanced the quality of recreational activities involving a barbecue.

Indeed, the aforesaid electric barbecue apparatuses make it convenient to barbecue, but there is still room for improvement. In particular, while continuously turning the food being barbecued does allow each part of the food to be heated evenly and can prevent overheating or even charring a certain part of the food, a common issue with some relatively bulky or thick pieces of food (e.g., a full chicken, ribs, or steaks) is that a user tends to have problem knowing the heated state inside the food. Because of that, a relatively chunky piece of food, when barbecued, is very likely to be fully cooked on the outside but undercooked inside. To avoid this, some users would buy a temperature probe and insert it into the food being barbecued in order to know the internal heated state, or more particularly the internal temperature, of the food. A conventional temperature probe includes a main machine, a conductive wire, and a probe, wherein the conductive wire is connected between the main machine and the probe. Once the probe is inserted in a piece of food, the main machine receives a signal transmitted from the probe through the conductive wire and displays the temperature of the food. The foregoing procedure, though effective in making the internal heated state of the food known to the user to keep the food from being fully cooked only on the outside, has its inconveniences in terms of operation.

First of all, although a conventional temperature probe can display the internal temperature of food, it is required that the user pay attention to the temperature displayed on the main machine. The user, therefore, cannot feel relaxed, let alone partaking in other activities. Moreover, if the probe is inserted in a piece of food through which a barbecue spit extends, and the main machine is placed beside the barbecue stove over which the barbecue spit is rotated by a power device, the conductive wire between the main machine and the probe will be wound around the barbecue spit or even the food, which turns along with the barbecue spit. To prevent undesirable winding of the conductive wire, it is necessary to pull out the probe immediately after the internal temperature of the food is detected. The rapid removal of the probe, however, not only can make the user nervous, but also may impair the accuracy of the temperature detected, given the very short time for which the probe is inserted in the food. In a nutshell, a temperature probe is ideal for detecting the internal heated state of food, but its convenience of use and accuracy of measurement will be greatly reduced if used in conjunction with a conventional electric barbecue apparatus, whose design does not take into account the use of a temperature probe.

According to the above, a temperature probe tends to function ineffectively at a barbecue simply because a conventional electric barbecue apparatus is not configured for use with a temperature probe. Therefore, the issue to be addressed by the present invention is to design a barbecue spit which is equipped with a temperature probe and applicable to an electric barbecue apparatus so that the electric barbecue apparatus can work well with the temperature probe to facilitate barbecuing and prevent uneven heating of food.

### BRIEF SUMMARY OF THE INVENTION

In view of the various problems arising from a lack of coordination in design between a conventional electric barbecue apparatus and a temperature probe, the inventor of the present invention conducted extensive research and repeated design modifications based on years of practical experience and long-term observation of consumer needs. Finally, a barbecue spit with a temperature probe was successfully developed as disclosed herein. The present invention is intended to solve all the aforementioned problems, and substantially increase the convenience of use, of the conventional barbecue apparatuses so that the leisurely quality of a barbecue is ensured.

It is an object of the present invention to provide a barbecue spit equipped with a temperature probe and applicable to an electric barbecue apparatus. The barbecue spit includes a rod, a temperature setting device, a conductive wire, and a probe. The rod is configured to pierce a piece of food and can be connected to a power device of the electric barbecue apparatus so that the rod and the food pierced thereby can be driven to rotate by the power device, allowing the food to be heated evenly by a heat source of the electric barbecue apparatus. The temperature setting device is provided adjacent to one end of the rod and can be driven to rotate with the rod by the power device. The temperature setting device includes a control module and an alert module, wherein the control module is electrically connected to the alert module. The conductive wire is provided in the rod (or provided outside the rod, with a thermal insulation material coated on the conductive wire to prevent the conductive wire from being overheated) and has one end electrically connected to the temperature setting device. The probe has one end to be inserted into the food and an opposite end electrically connected to the other end of the conductive wire. Thus, through the conductive wire, the temperature setting device can receive a food temperature measured by the probe. When the food temperature reaches a predetermined temperature, the control module drives the alert module to generate an alert signal (e.g., a continuous sound), thereby informing the user of the roasted state of the food, with a view to preventing the food from being burned. During the roasting process, the rod and the food pierced thereby are continuously rotated, and the probe inserted in the food rotates with the food, too. As the temperature setting device is also driven to rotate with the rod by the power device, the conductive wire between the temperature setting device and the probe is kept from winding around itself or getting entangled while the food is roasted, and all this is achieved in the present invention by a simple and low-cost structure, without need to use a specially designed motor.

It is another object of the present invention to provide the foregoing barbecue spit, wherein the temperature setting device further includes an input module and a storage module. The input module is electrically connected to the control module and can be used by the user to input at least one setting parameter before the at least one setting parameter is transmitted by the input module to the control module. The storage module is electrically connected to the control module so that, after receiving the at least one setting parameter transmitted by the input module, the control module stores the at least one setting parameter into the storage module. The user, therefore, can input an anticipated temperature parameter or a time parameter into the temperature setting device via the input module, so as for the temperature parameter to be stored in the storage module as a predetermined temperature, or for the time parameter to be stored in the storage module as a predetermined time. Upon determining that the temperature measured by the probe has reached the predetermined temperature, the control module drives the alert module to generate an alert signal. Or, when a timing unit of the temperature setting device determines that the predetermined time has passed, the control module drives the alert module to generate another alert signal. Thus, the user can freely set the condition (i.e., temperature or time) on which the temperature setting device generates each alert signal, and the alert signals make it redundant for the user to pay constant attention to the roasted state of the food, allowing the user to make better use of the time before either alert signal is generated. For example, the user may do such preparation work as washing, cutting, or marinating other food materials or do other house chores in the interim.

It is yet another object of the present invention to provide the foregoing barbecue spit, wherein the barbecue spit is configured for working with a wireless signal receiver and the temperature setting device further includes a wireless signal transmitting module. The wireless signal transmitting module is electrically connected to the control module and can be driven by the control module to transmit a wireless signal to the wireless signal receiver, so as for the wireless signal receiver to generate a notification signal (e.g., a continuous sound, flashing light, or vibrations) according to the wireless signal. Thus, the user is no more required to stay beside the electric barbecue apparatus during the entire barbecuing process; all the user has to do is to carry the wireless signal receiver with him or her in order to receive the notification signal in a timely manner.

### BRIEF DESCRIPTION OF THE SEVERAL VIEWS OF THE DRAWINGS

The above and other objects, as well as the structure and effects, of the present invention will be best understood by referring to the following detailed description of some illustrative embodiments in conjunction with the accompanying drawings, in which:

FIG. 1 is a structural diagram showing the present invention applied to an electric barbecue apparatus;

FIG. 2 is a schematic exploded view of a preferred embodiment of the present invention; and

FIG. 3 is a block diagram showing how the elements of the preferred embodiment of the present invention are connected.

### DETAILED DESCRIPTION OF THE INVENTION

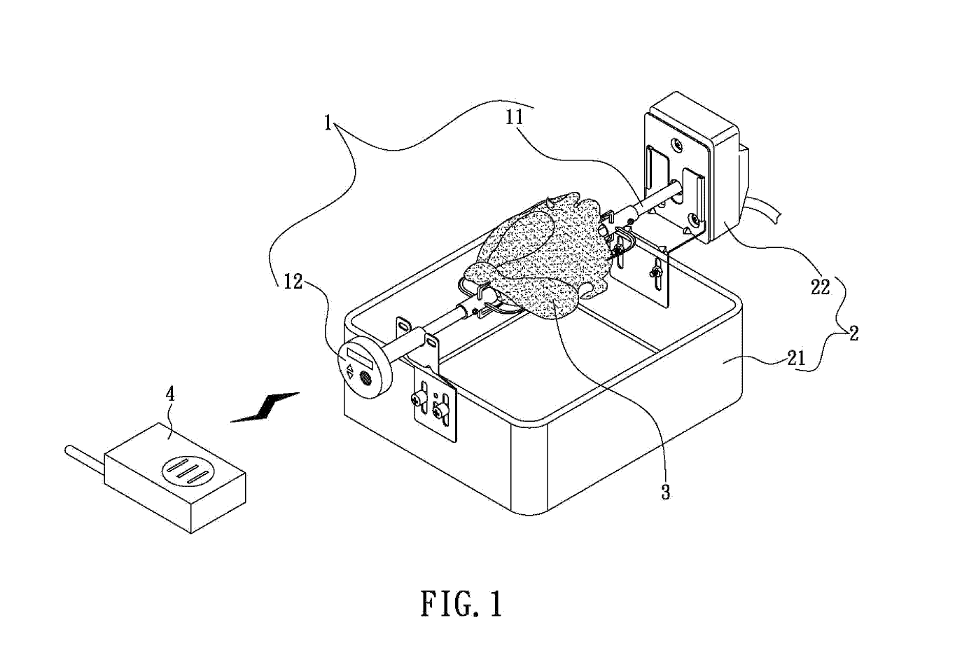

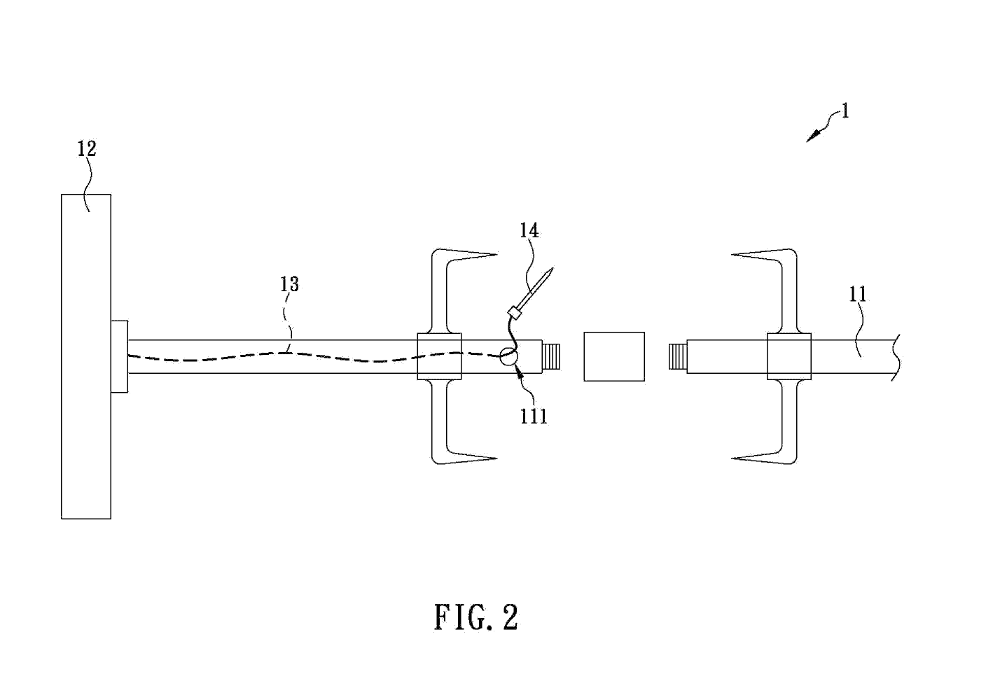

The present invention provides a barbecue spit equipped with a temperature probe. Referring to FIG. 1 and FIG. 2, the barbecue spit 1 is applied to an electric barbecue apparatus 2 which includes a barbecue stove 21 and a power device 22. The barbecue stove 21 provides a heat source (e.g., by burning gas from a gas stove or by turning on a halogen lamp in the barbecue stove 21). The power device 22 is mounted to the barbecue stove 21. The barbecue spit 1 includes a rod 11, a temperature setting device 12, a conductive wire 13, and a probe 14. The rod 11, which is configured to be inserted through a piece of food 3, can be connected to the power device 22 of the electric barbecue apparatus 2 so that the rod 11 and the food 3 through which the rod 11 is inserted can be driven to rotate by the power device 22, allowing the heat source of the electric barbecue apparatus 2 to heat the food 3 evenly.

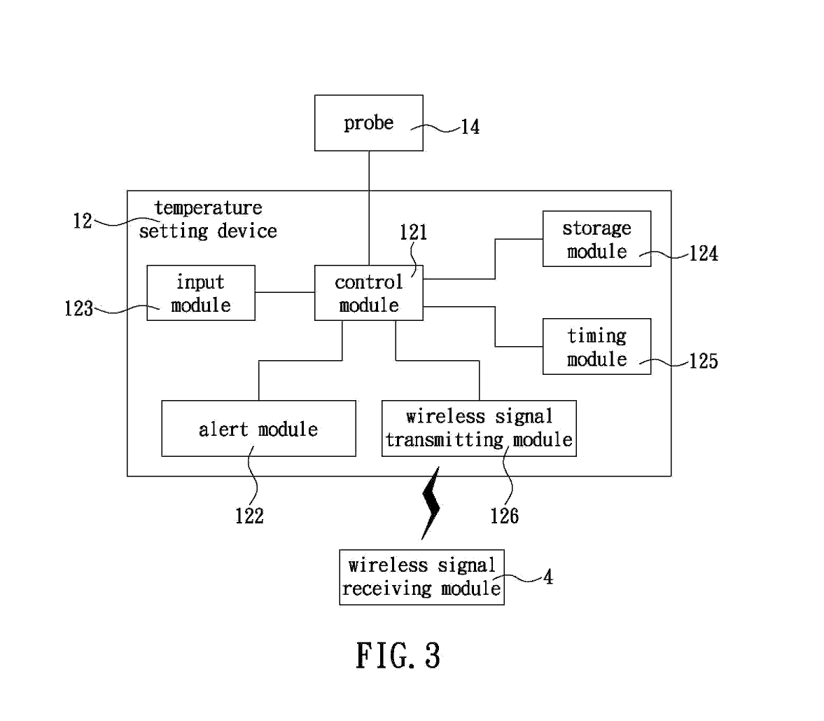

Referring to FIG. 2 and FIG. 3, the temperature setting device 12 is provided adjacent to one end of the rod 11 and can be driven to rotate with the rod 11 by the power device 22. The temperature setting device 12 includes a control module 121 and an alert module 122, wherein the control module 121 is electrically connected to the alert module 122. In this preferred embodiment, one end of the conductive wire 13 is electrically connected to the temperature setting device 12, and the rod 11 is a hollow tube for receiving the conductive wire 13 therein. The probe 14 has one end to be inserted into the food 3 (as shown in FIG. 1) and an opposite end electrically connected to the other end of the conductive wire 13. In this preferred embodiment, the rod 11 is formed with a probe opening 111 whose position corresponds to where the food 3 is fixed. Thus, the probe 14 is allowed to extend out of the rod 11 through the probe opening 111 and be inserted into the food 3. It should be pointed out that the rod 11, the conductive wire 13, and the probe 14 need not be configured and arranged in exactly the same way as described above. For example, the rod 11 may be designed as a solid rod, with the conductive wire 13 fixed to the exterior of the rod 11 and extending from the exterior of the rod 11 to a position adjacent to the food 3 to enable insertion of the probe 14 into the food 3. Further, the conductive wire 13 may be adjusted in length and coated with a thermal insulation material so that the conductive wire 13 will not be too close to or overheated by the heat source while the rod 11 and the food 3 are rotated. All such alternative configurations and arrangements are feasible implementation modes of the present invention.

In the preferred embodiment as shown in FIG. 2 and FIG. 3, the temperature setting device 12 further includes an input module 123 and a storage module 124. The input module 123 is electrically connected to the control module 121. A user can input at least one setting parameter through the input module 123 in order for the input module 123 to transmit the at least one setting parameter to the control module 121. The storage module 124 is also electrically connected to the control module 121. The control module 121 receives the at least one setting parameter transmitted by the input module 123 and stores the at least one setting parameter into the storage module 124. In the first implementation mode of this preferred embodiment, for example, the at least one setting parameter is a temperature parameter, and the control module 121 stores the temperature parameter as a predetermined temperature. If the control module 121 determines that a food temperature which is measured by the probe 14 and then received by the temperature setting device 12 through the conductive wire 13 reaches the predetermined temperature, the control module 121 will drive the alert module 122 to generate an alert signal (e.g., a continuous sound or flashing light), informing the user of the roasted state of the food 3 (see FIG. 1) and allowing the user to take necessary actions to prevent the food 3 from being roasted for too long. Otherwise, the food 3 may lose its optimal taste or even end up burned.

In the preferred embodiment described above, the temperature setting device 12 further includes a timing module 125. The timing module 125 is electrically connected to the control module 121 and can be driven to time by the control module 121. In the second implementation mode of the preferred embodiment, the at least one setting parameter is a time parameter, and the control module 121 stores the time parameter as a predetermined time. The timing module 125, upon determining that the predetermined time has elapsed, transmits a timing signal to the control module 121, thereby instructing the control module 121 to drive the alert module 122 according to the timing signal, causing the alert module 122 to generate a second alert signal (e.g., a continuous sound or flashing light). Hence, if the user decides to check the roasted state of the food 3 at a certain time interval regardless of the temperature of the food 3, the user can input the desired predetermined time through the input module 123, and the temperature setting device 12 will generate the second alert signal as soon as the predetermined time has passed, thereby urging the user to examine the roasted state of the food 3.

It can be known from the above that the temperature setting device 12 of the present invention can alert the user proactively either when the predetermined temperature is reached or when the predetermined time has elapsed. During the barbecuing process, therefore, the user need not spend a lot of time and energy watching the roasted state of the food 3. The present invention thus brings enhanced convenience to barbecues. Moreover, while the food 3 is being roasted, the power device 22 drives the temperature setting device 12 to rotate with the rod 11 such that, even though the rod 11 and the food 3 through which the rod 11 is inserted keep turning and the probe 14 inserted in the food 3 rotates with the food 3, the conductive wire 13 connected between the temperature setting device 12 and the probe 14 will not wind around itself or become entangled. By contrast, a conventional temperature probe, if used to detect the temperature of the food 3, can only be inserted in the food briefly and must be pulled out as soon as possible, which operation not only causes tremendous mental stress to the user, but also may lower the accuracy of the temperature detected. When the barbecue spit 1 of the present invention is applied to the electric barbecue apparatus 2, on the other hand, the user can engage in other recreational activities with ease of mind during the roasting process, without having to insert and pull the probe 14 into and out of the food 3 repeatedly. Thus, the barbecue spit 1 features convenience of use and allows the probe 14 to take temperature measurements accurately.

In the foregoing preferred embodiment as shown in FIGS. 1, 2, and 3, the temperature setting device 12 further includes a wireless signal transmitting module 126. The wireless signal transmitting module 126 is electrically connected to the control module 121 and can be driven thereby to transmit a wireless signal. In this preferred embodiment, the barbecue spit 1 is configured for use with a wireless signal receiver 4, and the wireless signal receiver 4 can receive the wireless signal transmitted by the wireless signal transmitting module 126 and generate a notification signal (e.g., a continuous sound, flashing light, or vibrations) according to the wireless signal. Therefore, as long as the user carries the wireless signal receiver 4 with him or her and can receive the notification signal through the wireless signal receiver 4, the user does not have to stay beside the electric barbecue apparatus 2 and can partake in a wide variety of activities during the roasting process. It should be pointed out that the temperature setting device 12 in another embodiment of the present invention may be so designed that, instead of having the alert module 122 and the wireless signal transmitting module 126 as separate components, the wireless signal transmitting module 126 doubles as the alert module 122. In that case, the wireless signal can be viewed as an implementation mode of the aforesaid alert signals, and the user can be notified via the wireless signal receiver 4 just as well.

While the invention herein disclosed has been described by means of specific embodiments, numerous modifications and variations could be made thereto by those skilled in the art without departing from the scope of the invention set forth in the claims.

What is claimed is:

1. A barbecue spit with a temperature probe, applicable to an electric barbecue apparatus, the barbecue spit comprising:
a rod configured for insertion through a piece of food, the rod being connected to a power device of the electric barbecue apparatus so that the rod and the piece of food through which the rod is inserted can be driven to rotate by the power device, allowing the piece of food to be heated evenly by a heat source of the electric barbecue apparatus;
a temperature setting device provided adjacent to an end of the rod and being able to be driven to rotate with the rod by the power device, the temperature setting device comprising a control module and an alert module, the control module being electrically connected to the alert module;
a conductive wire having an end electrically connected to the temperature setting device; and
a probe having an end to be inserted into the piece of food and an opposite end electrically connected to an opposite end of the conductive wire, so as for the temperature setting device to receive through the conductive wire a food temperature measured by the probe, and for the control module to drive the alert module to generate an alert signal when the food temperature reaches a predetermined temperature.

2. The barbecue spit of claim 1, wherein the rod is a hollow tube for receiving the conductive wire therein, and the rod is formed with a probe opening at a position corresponding to where the piece of food is fixed, thus allowing the probe to extend out of the rod through the probe opening and be inserted into the piece of food.

3. The barbecue spit of claim 2, wherein the temperature setting device further comprises:
an input module electrically connected to the control module so that at least a setting parameter can be input through the input module and be transmitted by the input module to the control module; and
a storage module electrically connected to the control module so as for the control module to, upon receiving the at least a setting parameter transmitted by the input module, store the at least a setting parameter into the storage module.

4. The barbecue spit of claim 3, wherein the at least a setting parameter is a temperature parameter, and the control module stores the temperature parameter as the predetermined temperature.

5. The barbecue spit of claim 4, wherein the temperature setting device further comprises a timing module electrically connected to the control module, and the at least a setting parameter is a time parameter, the control module storing the time parameter as a predetermined time and being configured to drive the timing module to time, the timing module transmitting a timing signal to the control module upon determining that the predetermined time has elapsed, thereby instructing the control module to, according to the timing signal, drive the alert module to generate another alert signal.

6. The barbecue spit of claim 4, wherein the temperature setting device further comprises a wireless signal transmitting module electrically connected to the control module, and the wireless signal transmitting module can be driven by the control module to transmit a wireless signal, so as for a wireless signal receiver to generate a notification signal according to the wireless signal upon receiving the wireless signal.

7. The barbecue spit of claim 5, wherein the temperature setting device further comprises a wireless signal transmitting module electrically connected to the control module, and the wireless signal transmitting module can be driven by the control module to transmit a wireless signal, so as for a wireless signal receiver to generate a notification signal according to the wireless signal upon receiving the wireless signal.

8. The barbecue spit of claim 4, wherein the alert module is a wireless signal transmitting module, and each said alert signal is a wireless signal so as for a wireless signal receiver to generate a notification signal according to the wireless signal upon receiving the wireless signal.

9. The barbecue spit of claim 5, wherein the alert module is a wireless signal transmitting module, and each said alert signal is a wireless signal so as for a wireless signal receiver to generate a notification signal according to the wireless signal upon receiving the wireless signal.
